(19) United States
(12) Patent Application Publication
(10) Pub. No.: US 2019/0272164 A1
(43) Pub. Date: Sep. 5, 2019

(54) SOFTWARE MANAGEMENT SYSTEM AND SOFTWARE MANAGEMENT METHOD

(71) Applicants: Toyota Jidosha Kabushiki Kaisha, Toyota-shi Aichi-ken (JP); Denso Corporation, Kariya-city Aichi-pref (JP)

(72) Inventors: Naoki Yamamuro, Nagoya-shi Aichi-ken (JP); Shinichi Adachi, Kariya-shi Aichi-ken (JP); Ryo Hattori, Kariya-shi Aichi-ken (JP); Taichi Amakasu, Toyota-shi Aichi-ken (JP); Keigo Hiruma, Kariya-shi Aichi-ken (JP)

(21) Appl. No.: 16/288,639

(22) Filed: Feb. 28, 2019

(30) Foreign Application Priority Data
Mar. 2, 2018 (JP) 2018-037379

(51) Int. Cl. G06F 8/65; H04L 29/08; G06F 8/10

(52) U.S. Cl. CPC G06F 8/65; G06F 8/10; H04L 67/34

(57) ABSTRACT

The present disclosure allows vehicle software to be updated in accordance with legal regulations. According to the present disclosure, when predetermined software which is vehicle software installed in a vehicle and which is a target of legal regulations is requested to be updated, update unit updates the predetermined software by using updating software for the predetermined software only in a case where predetermined certificate information in accordance with legal regulations is determined by determination unit to be attached to the updating software.

### CROSS-REFERENCE TO RELATED APPLICATION

This application claims the benefit of Japanese Patent Application No. 2018-037379, filed on Mar. 2, 2018, which is hereby incorporated by reference herein in its entirety.

### BACKGROUND

### Technical Field

The present disclosure relates to a software management system and a software management method that manage vehicle software.

### Description of the Related Art

Nowadays, various types of vehicle software are installed in a vehicle. As the vehicle software, software related to navigation (navigation software), software related to control of traveling of a vehicle (travel control software) and the like may be cited, for example. Some of these pieces of vehicle software may be updated as appropriate. Accordingly, a technique for updating vehicle software installed in a vehicle by using wireless communication or the like is being developed.

For example, Patent document 1 discloses a system that updates software related to an automated driving function or a driving support function of a vehicle in a case where update is permitted by a user. With the system disclosed in Patent document 1, in the case where it is determined that the software related to an automated driving function or a driving support function of a vehicle has to be updated, a user is urged to perform an operation for permitting update of the software, by partially or entirely restricting an operation of the automated driving function or the driving support function.

Patent document 2 discloses a technique for performing data communication between an application server and a vehicle through a charging station for charging a storage battery provided in the vehicle.

### Citation List

### Patent document

[Patent document 1] Japanese Patent Laid-Open No. 2017-167646 [Patent document 2] National Publication of International Patent Application No. 2012-526409

### SUMMARY

With electrification and automation of vehicles, vehicle software installed in vehicles is expected to become increasingly diverse. This means that the vehicle software will be more and more often requested to be updated. However, if there are no legal regulations for update of the vehicle software, there is a possibility that safety for traveling of a vehicle is not reliably maintained. Accordingly, legal regulations are expected to become necessary for at least some types of vehicle software related to control of traveling of a vehicle or safety technology, for example.

The present disclosure has been made in view of such circumstances, and has its object to provide a technique for enabling vehicle software to be updated in accordance with legal regulations.

A software management system according to a first aspect of the present disclosure is
a software management system that manages vehicle software, the software management system may include:
update unit configured to update software that is installed in a vehicle; and
determination unit configured to determine whether predetermined certificate information in accordance with legal regulations is attached to updating software or not, where
when update of predetermined software that is a target of legal regulations is requested, the update unit updates the predetermined software by using updating software for the predetermined software only in a case where the determination unit determines that the predetermined certificate information is attached to the updating software.

In the present aspect, software that is a target of legal regulations, among pieces of vehicle software, is taken as the predetermined software. As the predetermined software, software related to safety during traveling of a vehicle (software related to control of traveling of a vehicle, safety technology or the like) may be cited, for example. Such predetermined software has to be certified as complying with legal regulations, and predetermined certificate information is assigned as an evidence upon the certification. Accordingly, if predetermined software is legitimate, the predetermined certificate information in accordance with legal regulations is attached to information (control information) regarding control of hardware and application that is meant to be provided by the predetermined software.

Accordingly, with the software management system according to the present aspect, when update of the predetermined software installed in a vehicle is requested, whether the predetermined certificate information is attached to the updating software for the predetermined software or not is determined by the determination unit. The update unit may update the predetermined software by using the updating software only in a case where the determination unit determines that the predetermined certificate information is attached to the updating software. In other words, if the predetermined certificate information is not attached to the updating software, the update unit may not update the predetermined software by the updating software.

Accordingly, in a case where the updating software is not certified with respect to legal regulations, the predetermined software is not updated. The predetermined software may therefore be updated in accordance with legal regulations.

The software management system according to the present aspect may further include a specific server device that is legally permitted to transmit the updating software for the predetermined software to the vehicle. In this case, the updating software to which the predetermined certificate information is attached is transmitted to the vehicle only from the specific server device. Accordingly, the updating software for the predetermined software is not transmitted from a server device other than the specific server device which is legally permitted to transmit the updating software. The predetermined software may thus be managed highly securely.

A software management method according to a second aspect of the present disclosure is
a software management method of managing vehicle software, the software management method may include the steps of:
determining whether update of predetermined software that is a target of legal regulations is requested or not;
determining, in a case where update of the predetermined software is determined to be requested, whether predetermined certificate information in accordance with legal regulations is attached to updating software for the predetermined software or not; and
updating the predetermined software by the updating software only in a case where the predetermined certificate information is determined to be attached to the updating software.

According to the present disclosure, vehicle software may be updated in accordance with legal regulations.

### BRIEF DESCRIPTION OF THE DRAWINGS

FIG. 1 is a diagram schematically illustrating an overall configuration of a vehicle software management system according to a first embodiment;

FIG. 2 is a block diagram schematically illustrating a part of a configuration of a vehicle and a software management server according to the first embodiment;

FIG. 3 is a flowchart illustrating a flow of a process for updating travel control software, which is performed by a travel control device;

FIG. 4 is a flowchart illustrating a flow of a process for updating navigation software, which is performed by a navigation device; and

FIG. 5 is a diagram schematically illustrating an overall configuration of a vehicle software management system according to a second embodiment.

### DETAILED DESCRIPTION

Hereinafter, specific embodiments of the present disclosure will be described with reference to the drawings. Dimensions, materials, shapes, relative positions and the like of structural components described in the present embodiments are not intended to limit the technical scope of the disclosure unless specified otherwise.

### First Embodiment

### System Overview

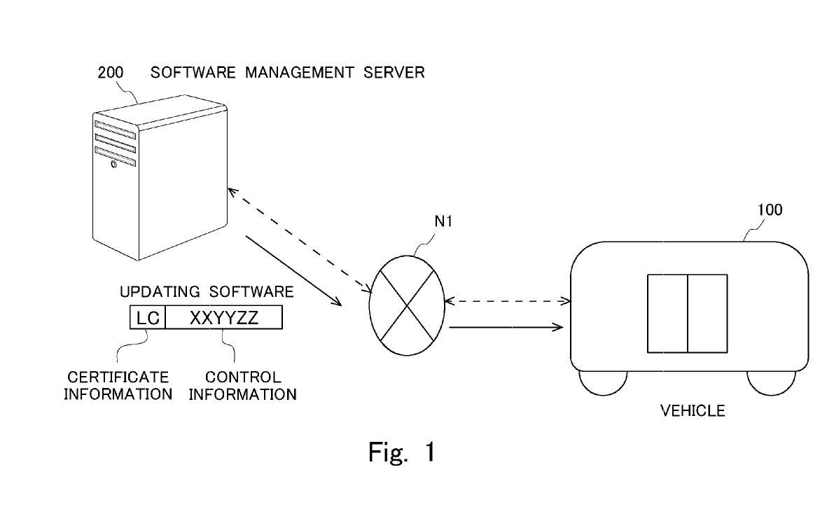

FIG. 1 is a diagram schematically illustrating an overall configuration of a vehicle software management system according to a present embodiment. In the vehicle software management system according to the present embodiment, a vehicle 100 and a software management server 200 are connected to each other through a network N1, such as the Internet, which is a public communication network. The software management server 200 is a server device that manages various types of software that are installed in the vehicle 100. In the case of updating vehicle software installed in the vehicle 100, updating software is transmitted from the software management server 200 to the vehicle 100 by wireless communication through the network N1.

The present embodiment assumes that some pieces of software, such as software related to safety during traveling of a vehicle, among vehicle software installed in the vehicle 100, are targets of legal regulations. In the following, software which is a target of legal regulations is sometimes referred to as “legally regulated software”. Legally regulated software has to be certified as complying with legal regulations at a stage before installation in a vehicle, and predetermined certificate information is assigned to the certified software. Accordingly, in the case where legally regulated software installed in the vehicle 100 is to be legitimately updated, updating software in a state where the predetermined certificate information is attached to control information regarding control of hardware and application that is meant to be provided by the legally regulated software is transmitted from the software management server 200 to the vehicle 100. In contrast, in the case of updating software which is not a target of legal regulations (hereinafter sometimes referred to as “general software”), information corresponding to the predetermined certificate information is not attached, and updating software consisting of the control information is transmitted from the software management server 200 to the vehicle 100. Additionally, in the present embodiment, the legally regulated software corresponds to “predetermined software” according to the present disclosure.

### Configuration of Vehicle and Software Management Server

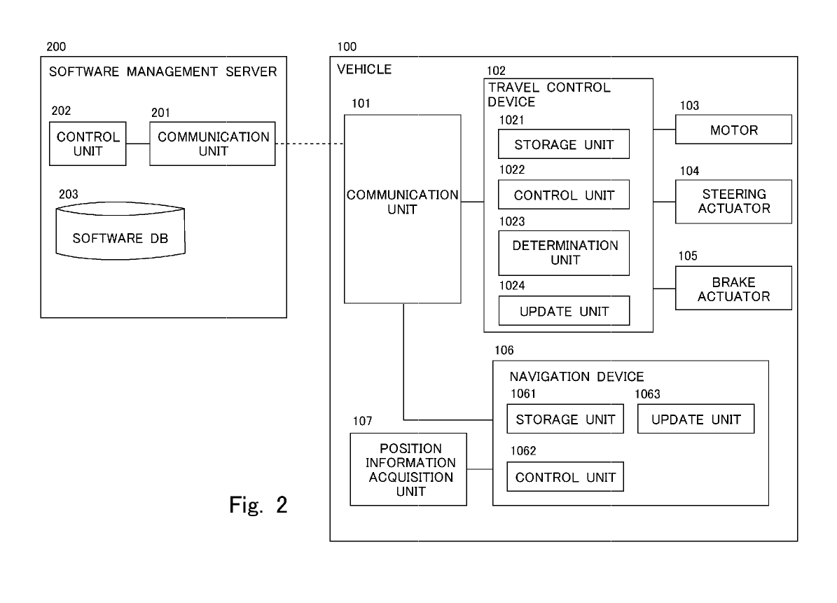

Next, a configuration of the vehicle 100 and the software management server 200 is described with reference to FIG. 2. FIG. 2 is a block diagram schematically illustrating a part of a configuration of the vehicle and the software management server according to the present embodiment.

The vehicle 100 includes a communication unit 101, a travel control device 102, a motor 103, a steering actuator 104, a brake actuator 105, a navigation device 106, and a position information acquisition unit 107. The communication unit 101 is a communication interface that connects the vehicle 100 to the network N1. In the present embodiment, communication with other devices such as the software management server 200 may be performed through the network N1 by using a mobile communication service such as 3G or LTE. As described later, the vehicle 100 receives the updating software from the software management server 200 through the communication unit 101.

The motor 103 is an electric motor which is a prime mover of the vehicle 100. However, the prime mover of the vehicle 100 is not limited to the electric motor, and may alternatively be an internal combustion engine. Furthermore, the vehicle 100 may be a hybrid vehicle including both the motor and the internal combustion engine as the prime movers. The steering actuator 104 is an actuator for operating steering of the vehicle 100. The brake actuator 105 is an actuator for operating a brake of the vehicle 100.

The travel control device 102 is a device that controls traveling of the vehicle 100, and includes a computer. Various sensors (not illustrated) that detect a traveling state and a surrounding state of the vehicle 100 are arranged in the vehicle 100. The travel control device 102 controls the motor 103, the steering actuator 104, the brake actuator 105 and the like based on detection values of the sensors, and thereby controls traveling of the vehicle 100. Additionally, as the control of traveling performed by the travel control device 102, electronic stability control (ESC), adaptive cruise control (ACC), lane keeping assist (LKA) and the like may be cited, for example. The travel control device 102 includes a storage unit 1021, a control unit 1022, a determination unit 1023, and an update unit 1024 as functional modules. The storage unit 1021 stores travel control software, which is software including a control program used by the travel control device 102 to control traveling. The control unit 1022 controls the motor 103, the steering actuator 104, and the brake actuator 105 by executing control programs included in the travel control software stored in the storage unit 1021. The determination unit 1023 and the update unit 1024 are functional units that function at the time of update of the travel control software stored in the storage unit 1021. Specific functions of the determination unit 1023 and the update unit 1024 will be described later.

The position information acquisition unit 107 acquires a current position of the vehicle 100, and specifically includes a GPS receiver and the like. Information about the current position of the vehicle 100 acquired by the position information acquisition unit 107 is transmitted to the navigation device 106. The navigation device 106 is a device that guides a travel route of the vehicle 100 from the current position to a destination, and includes a computer. The navigation device 106 includes a storage unit 1061, a control unit 1062, and an update unit 1063. The storage unit 1061 stores navigation software, which is software including a control program used by the navigation device 106 to perform route guidance for the vehicle 100. The navigation device 106 acquires information about the current position of the vehicle 100 from the position information acquisition unit 107, and also acquires information about the destination of the vehicle 100, which is input through an input (not illustrated). Then, the control unit 1062 performs route guidance from the current position of the vehicle 100 to the destination by executing the control program included in the navigation software that is stored in the storage unit 1061. Specifically, a travel route of the vehicle 100 is created, and also, the travel route is displayed on a map that is displayed on a display arranged in an interior of the vehicle 100. A driver may be guided by audio with respect to a path of the vehicle 100 along the travel route. The update unit 1063 is a functional unit that functions at the time of update of the navigation software that is stored in the storage unit 1061. A specific function of the update unit 1063 will be described later.

Each functional module of the travel control device 102 and the navigation device 106 may be achieved by execution, by a central processing unit (CPU), of a program that is stored in respective storage such as a read only memory (ROM). A part or all of the functions may be achieved by a hardware circuit such as an ASIC or an FPGA.

Next, a description will be given of the software management server 200. The software management server 200 manages various types of vehicle software, installed in each of a plurality of vehicles 100, including the travel control software and the navigation software. Specifically, the software management server 200 includes a function of storing software that is installed in each vehicle 100, and a function of transmitting the updating software to the vehicle 100.

The software management server 200 includes a communication unit 201, a control unit 202, and a software database (software DB) 203. Like the communication unit 101 of the vehicle 100, the communication unit 201 is a communication interface for communicating with the vehicle 100 and the like through the network. The control unit 202 is in charge of control by the software management server 200. In the case of updating software that is installed in the vehicle 100, the control unit 202 transmits the updating software to the vehicle 100 through the communication unit 201.

In the software DB 203, information about a type of software that is installed, information about a version of each software, and the like are stored in association with identification information of each vehicle 100, with respect to each of a plurality of vehicles 100 being managed by the software management server 200. When updating software (such as a latest version of software) is acquired, the software management server 200 stores the updating software in the software DB 203. The control unit 202 transmits the updating software to the vehicle 100 which is an update target. Additionally, the software management server 200 does not have to be achieved by one computer, and may alternatively be achieved by cooperation of a plurality of computers.

### Operation of System

Next, an operation of the system at the time of update of the vehicle software which is installed in the vehicle 100 will be described. As described above, the vehicle software is categorized into legally regulated software and general software. Here, the travel control software including a control program used by the travel control device 102 to control traveling is cited as an example of the legally regulated software. In contrast, the navigation software including a control program used by the navigation device 106 to perform route guidance for the vehicle 100 is cited as an example of the general software. Accordingly, if the updating software for updating the travel control software that is installed in the travel control device 102 is legitimate, the updating software includes predetermined certificate information as evidence that compliance with legal regulations is certified, in addition to control information (i.e., the control program and the like) regarding control by the travel control device 102. That is, with respect to the travel control software, the software management server 200 acquires the updating software to which the predetermined certificate information is attached, and transmits the updating software to the vehicle 100. On the other hand, with respect to the updating software for updating the navigation software that is installed in the navigation device 106, even if the updating software is legitimate, control information regarding control of the navigation device 106 is included, but information corresponding to the predetermined certificate information is not included.

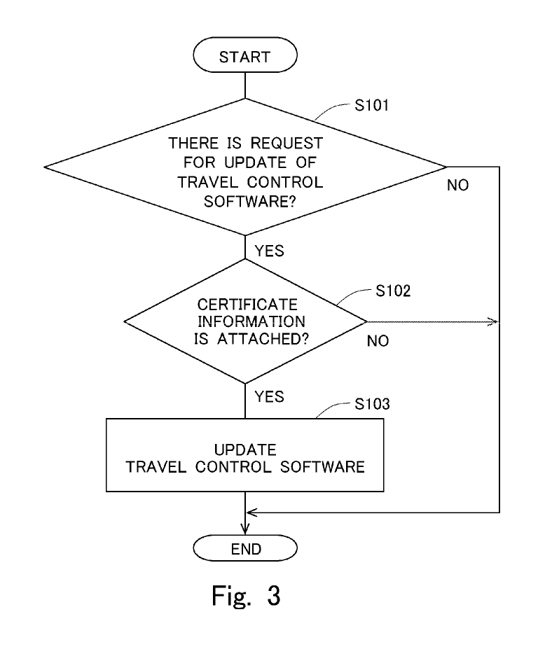

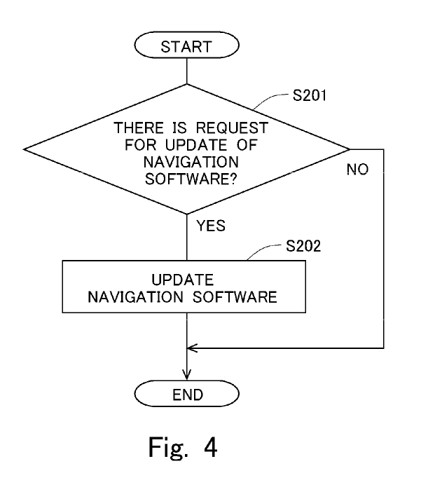

When updating software transmitted from the software management server 200 is received, the vehicle 100 stores the updating software in temporary storage (not illustrated) having a function of temporarily storing the updating software. Then, a process for updating the vehicle software corresponding to the updating software is performed at a predetermined timing when update is allowed. A process for updating the travel control software, which is performed by the travel control device 102, and a process for updating the navigation software, which is performed by the navigation device 106, will be described with reference to FIGS. 3 and 4, respectively. FIG. 3 is a flowchart illustrating a flow of the process for updating the travel control software, which is performed by the travel control device 102. FIG. 4 is a flowchart illustrating a flow of the process for updating the navigation software, which is performed by the navigation device 106. Both of the flows are performed by the respective devices at a predetermined timing when update is allowed. The predetermined timing when update is allowed is an appropriate timing for updating the vehicle software. Specifically, as the predetermined timing when update is allowed, a timing when power of the vehicle 100 is on but the motor 103 of the vehicle 100 is not driven (that is, a timing when the vehicle 100 is not traveling) or the like may be cited, for example.

First, the flow of the process for updating the travel control software, illustrated in FIG. 3, will be described. In the present flow, in S101, whether there is a request to update the travel control software or not is determined. Here, in the case where the vehicle 100 receives the updating software for updating the travel control software, the updating software is temporarily stored in temporary storage of the travel control device 102. When the updating software is stored in the temporary storage, an update request flag requesting update of the travel control software is turned on at the travel control device 102. In S101, if the update request flag is on, it is determined that there is a request to update the travel control software.

In the case where negative determination is made in S101, execution of the present flow is ended. In this case, the travel control software is, of course, not updated. On the other hand, in the case where positive determination is made in S101, a process in S102 is performed next. In S102, whether the predetermined certificate information is attached to the updating software that is stored in the temporary storage or not is determined by the determination unit 1023 of the travel control device 102. That is, in S102, whether the updating software for updating the travel control software is legitimate software which is certified as complying with legal regulations or not is determined. Then, in the case where negative determination is made in S102, or in other words, in the case where the predetermined certificate information is not attached to the updating software, execution of the present flow is ended. That is, even when the updating software for updating the travel control software is received, update of the travel control software by the updating software is not performed. In this case, the updating software that is stored in the temporary storage of the travel control device 102 is removed. At this time, a user of the vehicle 100 may be notified that the travel control software is not updated and that the updating software is removed. When negative determination is made in S102, and execution of the present flow is ended, the update request flag requesting update of the travel control software is turned off.

In the case where positive determination is made in S102, a process in S103 is performed next. In S103, the travel control software is updated by the update unit 1024 of the travel control device 102, by the updating software that is stored in the temporary storage. That is, the travel control software that is stored in the storage unit 1021 up to then is received from the software management server 200 and updated to the updating software that is stored in the temporary storage. Then, when execution of the present flow is ended, the update request flag requesting update of the travel control software is turned off. Also in this case, the updating software that is stored in the temporary storage of the travel control device 102 is removed.

Next, the flow of the process for updating the navigation software, illustrated in FIG. 4, will be described. In the present flow, in S201, whether there is a request to update the navigation software or not is determined. Here, in the case where the vehicle 100 receives the updating software for updating the navigation software, the updating software is temporarily stored in temporary storage of the navigation device 106. When the updating software is stored in the temporary storage, an update request flag requesting update of the navigation software is turned on at the navigation device 106. In S201, if the update request flag is on, it is determined that there is a request to update the navigation software.

In the case where negative determination is made in S201, execution of the present flow is ended. In this case, the navigation software is, of course, not updated. On the other hand, in the case where positive determination is made in S201, a process in S202 is performed next. In S202, the navigation software is updated by the update unit 1063 of the navigation device 106, by the updating software that is stored in the temporary storage. That is, the navigation software that is stored in the storage unit 1061 up to then is updated to the updating software that is received from the software management server 200 and stored in the temporary storage. Then, when execution of the present flow is ended, the update request flag requesting update of the navigation software is turned off. Also, the updating software that is stored in the temporary storage of the navigation device 106 is removed.

As described above, when the updating software is received by the vehicle 100 with respect to the navigation software, which is general software, the navigation software is updated by the navigation device 106, by the updating software. On the other hand, when the updating software is received by the vehicle 100 with respect to the travel control software, which is legally regulated software, whether or not the predetermined certificate information is attached to the updating software is determined. The travel control software is updated by the travel control device 102, by the updating software, only in the case where the predetermined certificate information is attached to the updating software.

Accordingly, the travel control software is updated solely by the updating software including an evidence that compliance with legal regulations is certified (i.e., the predetermined certificate information). In other words, in the case where the updating software is not certified with respect to legal regulations, the travel control software is not updated. Accordingly, the travel control software, which is legally regulated software, may be updated in accordance with legal regulations.

Additionally, in the above description, the travel control software is cited as an example of the legally regulated software, and the navigation software is cited as an example of the general software, but the legally regulated software and the general software are not limited thereto. For example, the present disclosure may also be applied to a vehicle which is capable of performing autonomous driving, without being driven by a driver. In this case, software related to autonomous driving control of the vehicle may be treated as the legal regulated software. On the other hand, software related to control of multimedia installed in the vehicle to provide moving images and music to passengers may be treated as the general software.

### Example Modification

In the embodiment described above, whether or not the predetermined certificate information is attached to the updating software for updating the travel control software is determined on the side of the vehicle 100, but this determination may be performed on the side of the software management server 200. In this case, when the software management server 200 acquires the updating software for updating the travel control software from outside, whether or not the predetermined certificate information is attached to the acquired updating software is determined. Additionally, in this case, it may be determined that there is a request for update of the travel control software, when the updating software is acquired by the software management server 200 from outside. Then, the updating software is transmitted to the vehicle 100 only in the case where the predetermined certificate information is attached to the updating software. That is, in the case where it is determined at the software management server 200 that the predetermined certificate information is not attached to the updating software for updating the travel control software, the updating software is not transmitted to the vehicle 100. Also in this case, update is performed solely by the updating software including evidence that compliance with legal regulations is certified. Accordingly, the travel control software, which is legally regulated software, may be updated in accordance with legal regulations.

### Second Embodiment

In a present embodiment, updating software for vehicle software is transmitted to a vehicle from a plurality of software management servers. However, the software management servers that transmit the updating software for legally regulated software to the vehicle are limited to specific software management servers that are legally permitted to transmit the updating software.

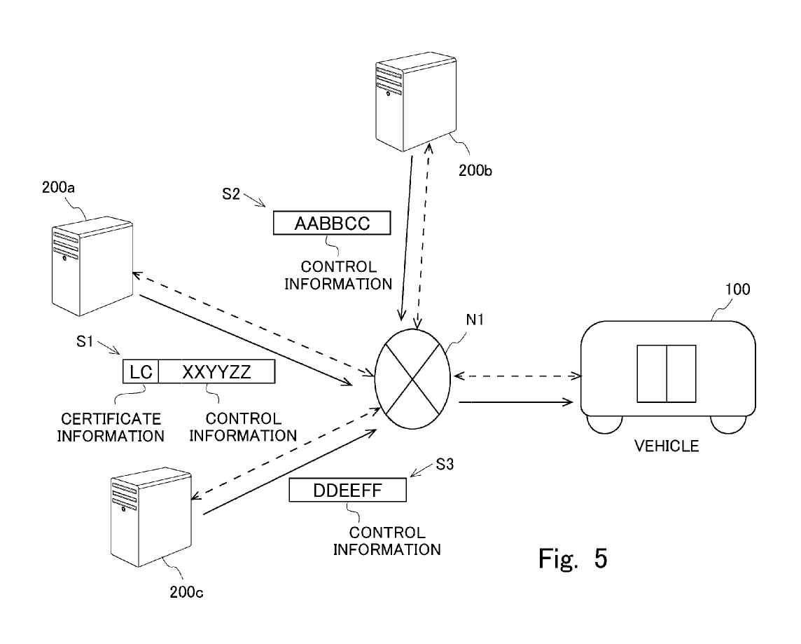

FIG. 5 is a diagram schematically illustrating an overall configuration of a vehicle software management system according to the present embodiment. With the vehicle software management system according to the present embodiment, the vehicle 100 and a plurality of software management servers 200a, 200b, 200c are connected through the network N1, such as the Internet, which is a public communication network. Pieces of updating software for different pieces of vehicle software are transmitted to the vehicle 100 from the software management servers 200a, 200b, 200c, respectively.

In FIG. 5, “S1” indicates the updating software that is transmitted from the software management server 200a to the vehicle 100, “S2” indicates the updating software that is transmitted from the software management server 200b to the vehicle 100, and “S3” indicates the updating software that is transmitted from the software management server 200c to the vehicle 100. The updating software S1 is the updating software for the travel control software, which is legally regulated software. Accordingly, the updating software S1 includes the predetermined certificate information, in addition to control information regarding control of the travel control device 102. That is, the predetermined certificate information is attached to the updating software S1. In contrast, the updating software S2, S3 is each software for the navigation software, which is general software. Accordingly, the updating software S2, S3 only include control information regarding control of the navigation device 106, but do not include information corresponding to the predetermined certificate information.

With the system configuration as illustrated in FIG. 5, among the plurality of software management servers 200a, 200b, 200c, only the software management server 200a is recognized as a specific server device that is legally permitted to transmit the updating software for the travel control software to the vehicle. Accordingly, the updating software for the travel control software is transmitted only from the software management server 200a, among the plurality of software management servers 200a, 200b, 200c, and is not transmitted from the software management servers 200b, 200c.

As described above, the updating software for legally regulated software is not transmitted from a server device other than a specific software management server that is legally permitted to transmit the updating software, and thereby the legally regulated software may be managed highly securely.

Additionally, the specific software management server and the vehicle may be connected through a dedicated communication line, instead of the network N1, which is a public communication network. For example, the specific software management server and the vehicle may be connected by near field wireless communication using Bluetooth (registered trademark) Low Energy standard, near field communication (NFC), ultra-wideband (UWB), Wi-Fi (registered trademark), or the like. The updating software for the legally regulated software may be transmitted to the vehicle through the dedicated communication line.

What is claimed is:

1. A software management system that manages vehicle software, the software management system comprising:
update unit configured to update software that is installed in a vehicle; and
determination unit configured to determine whether predetermined certificate information in accordance with legal regulations is attached to updating software or not, wherein
when update of predetermined software that is a target of legal regulations is requested, the update unit updates the predetermined software by using the updating software for the predetermined software only in a case where the determination unit determines that the predetermined certificate information is attached to the updating software.

2. The software management system according to claim 1, further comprising a specific server device that is legally permitted to transmit the updating software for the predetermined software to the vehicle, wherein
the updating software to which the predetermined certificate information is attached is transmitted to the vehicle only from the specific server device.

3. A software management method of managing vehicle software, the software management method comprising the steps of:
determining whether update of predetermined software that is a target of legal regulations is requested or not;
determining, in a case where update of the predetermined software is determined to be requested, whether predetermined certificate information in accordance with legal regulations is attached to updating software for the predetermined software or not; and
updating the predetermined software by the updating software only in a case where the predetermined certificate information is determined to be attached to the updating software.
